(19) United States
(12) Patent Application Publication
(10) Pub. No.: US 2003/0063742 A1
(43) Pub. Date: Apr. 3, 2003

(54) Method and apparatus for generating a strong random number for use in a security subsystem for a processor-based device

(76) Inventors: E. David Neufeld, Magnolia, TX (US); Andrew Brown, Houston, TX (US)

Correspondence Address: Michael G. Fletcher, Fletcher, Yodar & Van Someren, P.O. Box 692289, Houston, TX, 77269-2289, US

(21) Appl. No.: 09/966,890

(22) Filed: Sep. 28, 2001

(51) Int. Cl. H04L 9/00

(52) U.S. Cl. 380/46

(57) ABSTRACT

A technique for generating a strong random number for use in a cryptographic security system for a processor-based device is provided. The technique is particularly useful for restoring a random number to memory after data in the memory has been lost due to, for example, loss of backup power. Bits comprising a random number are automatically and iteratively written to the memory when another authorized device or application program attempts to access the processor-based device. Further randomness also may be provided by masking in additional bits whenever main power is cycled to the processor-based device.

### BACKGROUND OF THE INVENTION

1. Field of the Invention

The present invention relates generally to a security system for a processor-based device and, more particularly, to a technique for generating a strong random number for use in the security subsystem in a networked processor-based device, such as a server or management subsystem.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Computer security is becoming increasingly important in today's environment of heavily networked computer systems. As a result, security and integrity features are becoming desirable in the use of personal computers and servers. Providing “security”=0 for a system involves protecting the system from a variety of possible attacks. Such security provisions may include protecting a system from accesses by hackers or other unauthorized entities. For instance, for a specific business with proprietary internal systems and data, security provisions may involve prevention of rogue or external devices from accessing the internal machines. Prevention of access by unauthorized external devices may be particularly problematic if the internal system is configured for remote access via a publicly accessible network, such as the Internet.

One approach to security is the use of cryptography. Cryptography generally involves encryption of communications to prevent unauthorized access or reading of the communications. Encryption typically is accomplished through the use of a cryptographic algorithm, which is essentially a mathematical function. Most prevalent cryptographic algorithms are key-based algorithms, in which special knowledge of variable information called a “key” is required to encrypt and decrypt messages.

Two common types of key-based algorithms are a single key (or symmetric) algorithm and a “public key/private key” (or asymmetric) algorithm. A symmetric cryptographic algorithm is based on a secret, but shared, key which is used to both encrypt and decrypt messages. An asymmetric algorithm, in contrast, uses two related complementary keys: a publicly revealed key and a private (i.e., secret) key, each of which unlocks the code that the other key makes.

Symmetric cryptographic systems are not always practical and may be subject to attack since the sender and recipient of a message must somehow exchange information regarding the shared key. However, a symmetric system does provide for relatively quick encryption and decryption of messages.

On the other hand, asymmetric key systems, in which the public key and the private key are different, are relatively slower. In typical operation, the “public key” may be publicly available, such as via a readily accessible directory or the public portion of a digital certificate, while the corresponding “private key” is known only to the key pair owner. In an exemplary public key transaction, one party first attains the key pair owner's public key and uses it to encrypt a message prior to sending it. The key pair owner then decrypts the message with the corresponding private key.

Because public/private key encryption algorithms are slow relative to shared key systems, secure communications in many computing systems often are implemented using a hybrid approach in which a session between two parties may be initiated using a public key/private key system and then continued using a shared key. For instance, to initiate the session, one party may retrieve the other party's public key and use it to encrypt a shared key. The other party retrieves the shared key by decrypting it using the private key that corresponds to the public key. Further messages between the parties then may be encrypted/decrypted using the shared key and a symmetric algorithm. Accordingly, the problem with exchanging a shared secret key in a nonsecure environment is circumvented, while the significantly increased speed available from the symmetric, shared key system is provided.

To generate keys (either symmetric or Public/Private), the cryptographic algorithm uses a random number such that each key that is generated is unique and unpredictable. Typically, the random number is obtained by performing a mathematical operation on data stored in a “seed pool,” which essentially is a collection of randomly generated bits. The more random the manner in which the seed pool is generated and the larger the number of bits used, the greater the unpredictability of the generated keys, thus strengthening the security of the system.

In many instances, the seed pool is initialized and stored in non-volatile memory (e.g., ROM, EEPROM, flash memory, NVRAM) of the system while the system is in a “non-hostile” (i.e., limited security risk) environment. For example, the seed pool may be generated by a conventional random number generator and injected into non-volatile memory during the manufacturing process or while being serviced by authorized personnel. In the manufacturing environment, injection of the seed pool may be part of the system initialization process or a step (or station) in the manufacturing process. In a service environment, injection of a seed pool may be allowed only if a large number of highly unpredictable bits can be obtained.

Once the seed pool is placed into memory, the cryptographic algorithm may use the seed pool to generate keys. In many systems, the non-volatile memory in which the seed pool is stored is backed up by a replaceable, limited life power source, such as a lithium battery. It is not unusual that such power sources may require replacement every four to five years. Unfortunately, if the power source for the non-volatile memory is removed or loses energy, data stored in the non-volatile memory will be lost. As a result, the seed pool for the cryptographic security system will be destroyed, thus disabling the generation of future strong keys and secure access to the system by an external device.

An approach to re-establishing the seed pool would be to provide a feature whereby the seed pool could be repopulated by an authorized person during a service event performed in a non-hostile environment. However, such a solution may not be optimal in all cases, because it would require the physical presence of an authorized technician having the appropriate tools. Accordingly, it would be useful to provide a feature whereby the seed pool automatically could be repopulated after power to the memory storing the seed pool has been removed and restored. It would be particularly useful if the re-establishment of the seed pool automatically would occur whenever an authorized external device attempts to access the computer system, either locally or remotely, and initiate a session.

The present invention may be directed to addressing one or more of the problems set forth above.

### DESCRIPTION OF THE DRAWINGS

The foregoing and other advantages of the invention will become apparent upon reading the following detailed description and upon reference to the drawings in which:

FIG. 1 illustrates a block diagram of an exemplary processor-based device;

FIG. 2 illustrates a block diagram representing an exemplary embodiment of a server which implements the random number generation technique in accordance with the invention;

FIG. 3 illustrates a block diagram representing an exemplary embodiment of random number generation logic within the server of FIG. 2;

FIG. 4 illustrates a flow chart of an exemplary technique for initiating a communication session between the server of FIG. 2 and an external device; and

FIG. 5 illustrates a flow chart of an exemplary technique for populating the seed pool 122 while initiating the communication session as shown in FIG. 4.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The invention described below may be employed in any of a variety of types of processor-based devices which benefit from the use of random numbers. For instance, random numbers may be particularly useful in conjunction with a cryptographic security system that may be employed to verify the identity and/or authority of an entity attempting to access the processor-based device, as well as to encrypt/decrypt messages between the processor-based device and an external device. Such messages may be exchanged over any of a variety of types of communication links, such as a wired connection, wireless connection, network, intranet, Internet, etc.

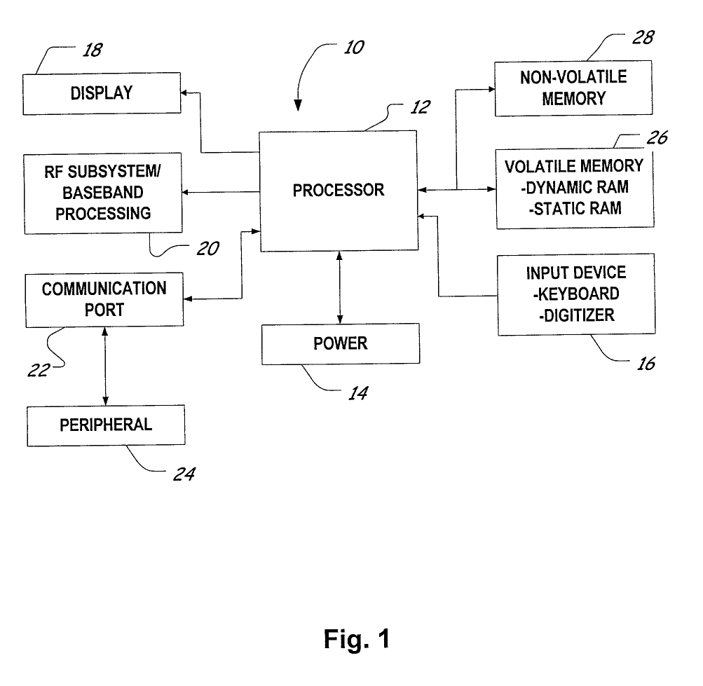

A block diagram depicting an exemplary processor-based device 10 is illustrated in FIG. 1. The device 10 may be any of a variety of different types, such as a desktop computer, portable computer, server, Internet appliance, pager, cellular telephone, personal digital assistant, control circuit, etc. In a typical processor-based device, a processor 12, such as a microprocessor, controls many of the functions of the device 10.

The device 10 typically includes a main power supply 14. For instance, if the device 10 is portable, the power supply 14 would advantageously include permanent batteries, replaceable batteries, and/or rechargeable batteries. The power supply 14 may also include an A/C adapter, so that the device may be plugged into a wall outlet, for instance. In fact, the power supply 14 may also include a D/C adapter, so that the device 10 may be plugged into a vehicle's cigarette lighter, for instance. In addition to the main power supply 14, the device 10 may include various back-up power supplies (not shown in FIG. 1) to provide back-up power for memory circuits. Such back-up power supplies may include a small battery, such as a lithium battery, which has a relatively long, but ultimately limited, life (e.g., four to five years).

Various other devices may be coupled to the processor 12 depending upon the functions that the device 10 performs. For instance, a user interface device 16 may be in communication with the processor 12 through appropriate user interface software. The user interface device 16 may include buttons, switches, a keyboard, a light pin, a mouse, and/or a voice recognition system, for instance. A display 18 may also be coupled to the processor 12. The display 18 may include an LCD display, a CRT, LEDs, and/or an audio display. Furthermore, an RF subsystem/baseband processor 20 may be coupled to the processor 12. The RF subsystem/baseband processor 20 may include an antenna that is coupled to an RF receiver and to an RF transmitter (not shown). A communications port 22 may also be coupled to the processor 12. The communications port 22 may be adapted to be coupled to a peripheral device 24, such as a modem, a printer, or a computer, for instance, or to a network, such as a local area network, an intranet and/or the Internet.

Because the processor 12 controls the functioning of the device 10 generally under the control of software programming, memory is coupled to the processor 12 to store and facilitate execution of the program. For instance, the processor 12 may be coupled to volatile memory 26, which may include dynamic random access memory (DRAM) and/or static random access memory (SRAM). The processor 12 may also be coupled to non-volatile memory 28. The non-volatile memory 28 may include a read only memory (ROM), such as an EPROM, and/or Flash memory, to be used in conjunction with the volatile memory. The size of the ROM is typically selected to be just large enough to store any necessary BIOS operating system, application programs, and fixed data. The volatile memory, on the other hand, is typically quite large so that it can store dynamically loaded applications. Additionally, the non-volatile memory 28 may include a high capacity memory such as a disk or tape drive memory.

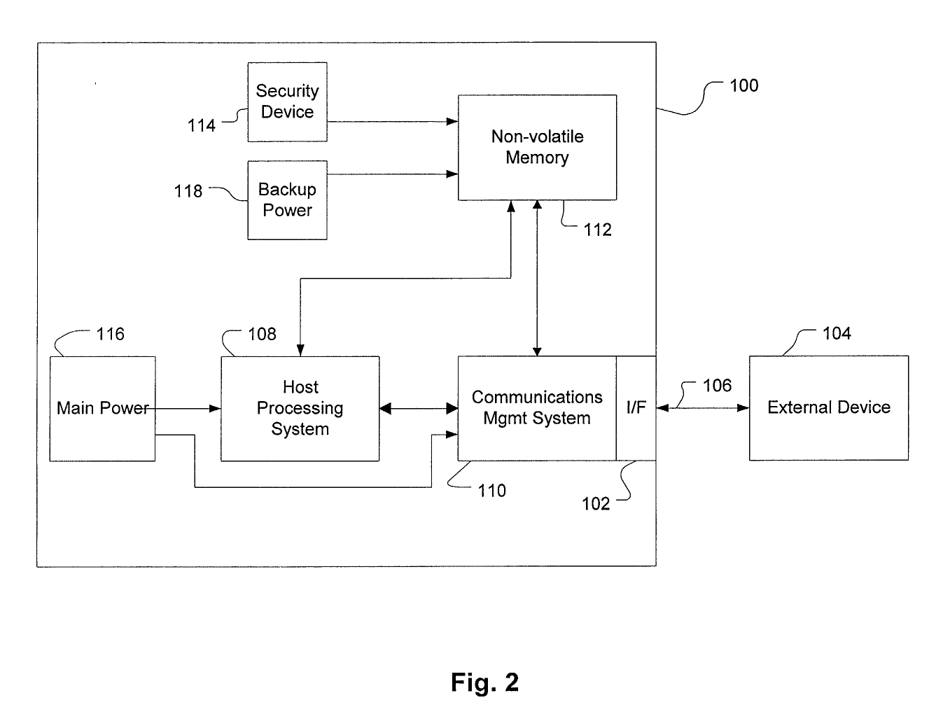

As previously discussed, the device 10 can be any of a variety of types of processor-based devices. In the exemplary embodiment described below with respect to FIGS. 2-5, the processor-based device 10 is a device 100 (e.g., a server) which has a communication port or interface 102 adapted for communication, either locally or remotely, with an external device 104 (i.e., another processor-based device) via a communication link 106. The communication link 106 may comprise a wired link and/or wireless link, and either may be a local link between the external device 104 and the server 100 or part of a network, such as a local area network, intranet, and/or Internet.

FIG. 2 illustrates a block diagram representing some of the functional blocks of the server 100. The server 100 includes a host processing system 108, which implements the features of the processor-based device 10 shown in FIG. 1. For instance, the host processing system 108 includes a microprocessor, such as a Merced® or Pentium® processor available from Intel Corporation, as well as any number of similar suitable processors available from other manufacturers. The host processing system 108 also includes a variety of buses, such as a host bus, a Peripheral Component Interface (PCI) bus, and an Industry Standard Architecture (ISA) bus. A memory system generally is coupled in an appropriate manner to the buses. The memory system may include devices such as a memory controller, cache memory, data buffers, random access memory, read only memory, video controller, video memory, etc.

The host processing system 108 also may include or communicate with miscellaneous system logic, such as counters, timers, interrupt controllers, power management logic, communications and security management logic (e.g., a communications management system 110), etc. In conjunction with the communications and security management logic, an interface device 102 may be provided, such as a network interface controller (NIC) or an RS232 interface controller.

In the exemplary embodiment illustrated in FIG. 2, the communications management system module 110 may include its own microprocessor to perform processing functions related to communicating with the external device 104 via the interface 102 and the communication link 106. For instance, the communications management system 110 may be configured to provide access to the host processing system 108 by an external device 104. Such access may be provided even in situations in which the host processing system 108 is not properly functioning, which may be particularly advantageous for retrieving data related to the operation of the server 100 such that maintenance, service, and/or control actions may be performed from the external device 104. Additionally, the external communication capability may provide for access to the processing capabilities of the server 100 by the device 104. Still further, the communication management system 110 may have hooks into other features of the host processing system 108, such as the input/output (e.g., PCI) bus(es). In any event, as discussed above, any provision of a feature which permits an external device to connect to and access the server 100 presents a security risk. Accordingly, the communications management system 110 further includes security management logic to restrict and govern external access to the server 100.

Both the host processing system 108 and the communications management system 110 have access to data stored in a non-volatile memory 112, which, in an exemplary embodiment, is included in the communications management system 110. The memory 112 may include a ROM, EPROM, flash memory, non-volatile RAM, and so forth, to store, for instance, a BIOS, security management data, etc. In certain applications, it may be desirable to limit access to portions of the memory 112 in which sensitive data (e.g., security-related data) is stored. In the exemplary embodiment, the server 100 is configured such that only the communications management system 110 has access to the security-related data stored in the memory 112.

Write accesses to the memory 112 or portions of the memory 112 may be restricted by a security device 114. In the exemplary embodiment, the security device 114 comprises a jumper wire which is installed in an appropriate location within the chassis of the server 100 during system initialization or a service event. If the security device 1 14 is not properly installed, then write accesses to protected memory portions may be denied. Further, the security device 114 should be removed upon completion of the initialization procedure or the service event to prevent unauthorized access to the restricted portions of the memory 112.

Both the host processing system 108 and the communications management system 110 derive power from a main power source 116. The main power source 116 may be a power supply connected to a conventional AC power source. Alternatively, the main power source 116 may include a battery.

A backup power source 118 also is provided to prevent loss or corruption of data stored in the memory 112. In the exemplary embodiment, the backup power source 118 comprises a lithium battery, which typically has a life of approximately four to five years. As discussed above, data related to the server's security system may be stored in the memory 112. In certain applications, the stored data may be necessary to authorizing an external device 104 to access the server 100. Thus, if the backup power source 118 fails or is removed, the security of further external accesses to the server 100 via the communications management system 110 will be compromised until the security data is rewritten to the protected portion of the memory 112.

Rewriting of the security data to the memory 112 may be accomplished by a service technician who is physically present at the location of the server 100. In the embodiment illustrated in FIG. 2, the service technician must open the chassis of the server 100, install the security device 114, and restore the security data to the memory 112 using an appropriate random number generator. Such a solution to re-establishing a secure, external communications capability may not be optimal, however, because it requires the physical presence of a properly trained technician, physical access to the server 100, and confidence that the technician will remove the security device 118 upon completion of the task. Thus, it would be convenient to provide an alternative feature whereby the security data could be restored in memory when an authorized external device 104 attempts to access the server 100 via the communications management system 110 even though the security device 114 is not present.

The present invention addresses the problem of restoring to the non-volatile memory 112 the security data which is used to generate the keys for the cryptographic security algorithm. It should be understood that the technique described herein is applicable to any situation in which such security data is generated, such as during an initialization process or as a result of the data having been lost or corrupted.

To heighten the security of a cryptographic system, it is important that the cryptographic keys be unique and highly unpredictable. As previously discussed, generation of a cryptographic key is based on a number (i.e., a collection of digital bits referred to as a “seed pool”) that is randomly generated. The more unpredictable or random the manner in which the bits are collected, the more secure the system will be. Thus, for a strong random number, even though the particular technique or algorithm for generating the collection of bits which combine to form the random number may be known, the actual value of the resultant random number should be unpredictable.

In the exemplary embodiment, the seed pool is a collection of 128 bytes (i.e., 1024 bits) of data. Seeding of the pool with the bits occurs in discrete increments, each increment corresponding to a triggering event having an unpredictable and variable duration or latency. For instance, each time the triggering event occurs, one or more bits are added to the seed pool upon termination of the triggering event if the seed pool is not already populated. In the exemplary embodiment, the bits are generated by a free running timer embedded in the communications management system 110, and the triggering event is receipt of a query from an external device 104 that is attempting to access the communications management system 110 via the interface 102. Termination of the triggering event occurs when the communications management system 110 transmits a response to the query from the external device 104. Thus, if as a result of the query the communications management system 110 determines that the seed pool is not fully populated, then the system 110 returns a negative response to the query and captures one or more bits of the timer (e.g., the four least significant bits) for the seed pool.

The time lapse between the initiation of the triggering event (i.e., the transmission of the query from the external device 104) and the termination of the triggering event (i.e., the transmission of the response to the query from the communications management system 110 to the external device 104) is unpredictable and variable, thus increasing the probability that the value of the one or more bits captured from the timer and placed in the seed pool also is unpredictable. Several variable factors contribute to the unpredictability of the timing of the event (i.e., the delay or latency introduced by the event). For instance, the hardware clocking in the controller in the interface 102 typically is asynchronous to processing functions performed in the communication management system 110, thus contributing a degree of uncertainty introduced by synchronization logic. Further, the delay in transmitting communications between the device 104 and the interface 102 is dependent on the bandwidth of the communication link 104 (which can vary depending on the particular system and link used) as well as the amount of other traffic contending for that bandwidth (which can vary in real time).

Other factors contributing to the unpredictability of the latency of the triggering event may include the number of communication packets in cache memory on either side of the communication link 104, the size of the TCP/IP stack on either side of the link 104, the length of the resultant TCP/IP communication packet transmitted on the link 104, the manner in which error checking is performed on the packets, etc. Still further, other variable delays may exist in determining whether the seed pool is adequately populated, and in generating a response to the query from the external device.

Other types of triggering events having an unpredictable and variable latency may be used to populate the seed pool. Alternatively, to provide an even greater degree of randomness, a second type of triggering event may be used in conjunction with a first type of triggering event, such that both events contribute to the population of the seed pool. For example, the first triggering event may be receipt of a query from an external device, as described in the paragraphs above. The second triggering event may be detection of a turn off/turn on cycle of the main power source 116 or a reboot of the server 100. Thus, for instance, each time the main power is cycled or the server is rebooted, one or more bits from the free running timer may be captured and masked into the seed pool.

As described above with respect to the first type of triggering event, the second event (e.g., a main power cycle) may result in addition of bits to the seed pool only if the seed pool already is not fully populated. However, in one exemplary embodiment, one or more bits from the free running timer are masked into the seed pool each time a main power cycle or reboot is detected, thus occasionally changing the state of, or refreshing, the seed pool regardless of whether the seed pool actually needs to be restored.

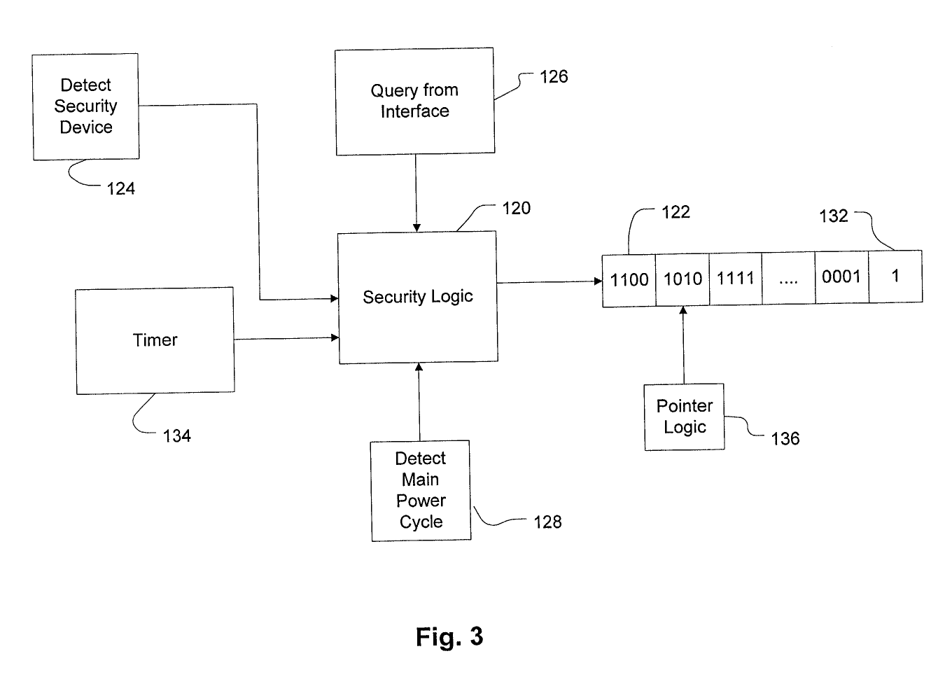

The logic of the communications and security management system 110 which initializes and/or restores the population of the seed pool is represented by the block diagram in FIG. 3. The logic may be implemented in any suitable manner in software, hardware, and/or firmware. As illustrated, security logic 120 receives or detects input information from several sources. For example, in FIG. 3, the logic 120 is configured to detect three types of triggering events which result in data being added to the seed pool 122: (1) the presence of a security device 114 that allows write accesses to the memory 112 (block 124); (2) a query received via the interface 102 as a result of an access request from an external device 104 (block 126); and (3) cycling of the main power source 116 (block 128). In the exemplary embodiment, the seed pool 122 is a collection of 1024 bits of data, which are added to the seed pool in increments of one or more bits in response to the occurrence of a triggering event.

In response to detection of a security device 114, the logic 120 is configured to generate an output signal which enables write accesses to the portion of the memory 112 in which the seed pool 122 is stored. In response to a query from an external device 104, the security logic 120 is configured to examine the seed pool 122 to determine whether it is adequately populated. For example, the logic 120 may examine the position of a pointer to determine whether the portion of the memory 112 for storing the seed pool 122 is full. Alternatively, the logic 120 may be configured to examine the state of a bit 132 in the memory 112 which is representative of the populated state of the seed pool 122. For example, the bit 132 may be reset any time power from the backup source 118 is removed and restored to the memory 112 and set when the seed pool 122 is fully populated. Full population of the seed pool 122 may be indicated by a counter (not shown) that counts, for instance, the number of queries received via the interface 102 from the external device 104. Alternatively, a count may be maintained of the number of times the logic 120 captures bits from the timer 134 and/or writes the captured bits to the seed pool 122. Once the communications management logic 110 can return an affirmative response to the external device 104 (indicating that the seed pool 122 is full), then the counter may be reset and the state of the bit 132 changed accordingly.

If the logic 120 determines that the seed pool 122 is not adequately populated, then the logic 120 reads the bits of a free-running timer 134 (e.g., the four least significant bits) and writes those bits to the seed pool 122. For example, the logic 120 may write the bits to the location in the memory 112 indicated by a seed pool pointer logic 136. The pointer logic 136 then may increment to the next location in the memory 112 for the seed pool 122.

Detection of a cycle of the main power source 116 or a reboot (block 128) also is a triggering event which results in the capture of one or more bits of the free-running timer 134. In the exemplary embodiment, upon detection of a main power cycle or reboot (block 128), the logic 120 is configured to mask into the seed pool 122 at the location indicated by pointer logic 136 the least significant bit of the timer 134, even if the pool 122 already is fully populated. The pointer logic 136 then may increment to a next location of the seed pool 122 in the memory 112. Occasionally masking bits into the seed pool 122 contributes a further degree of unpredictability (or entropy) in the generation of the random number for the cryptographic security system.

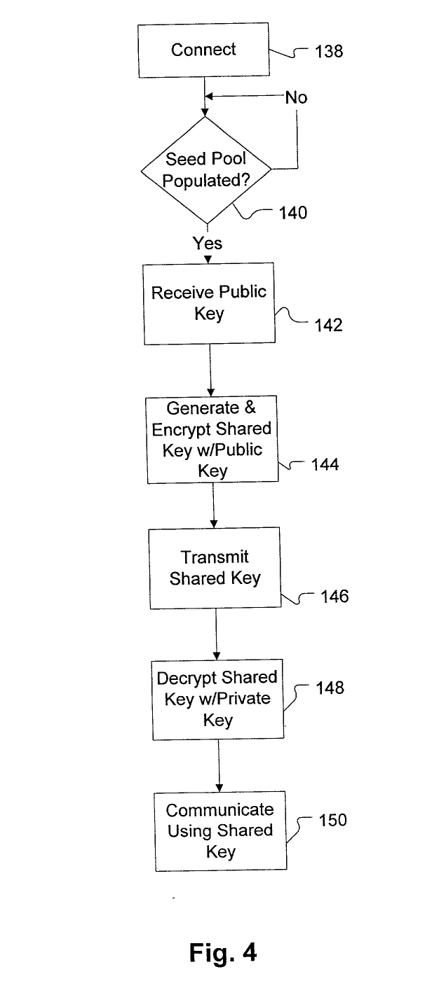

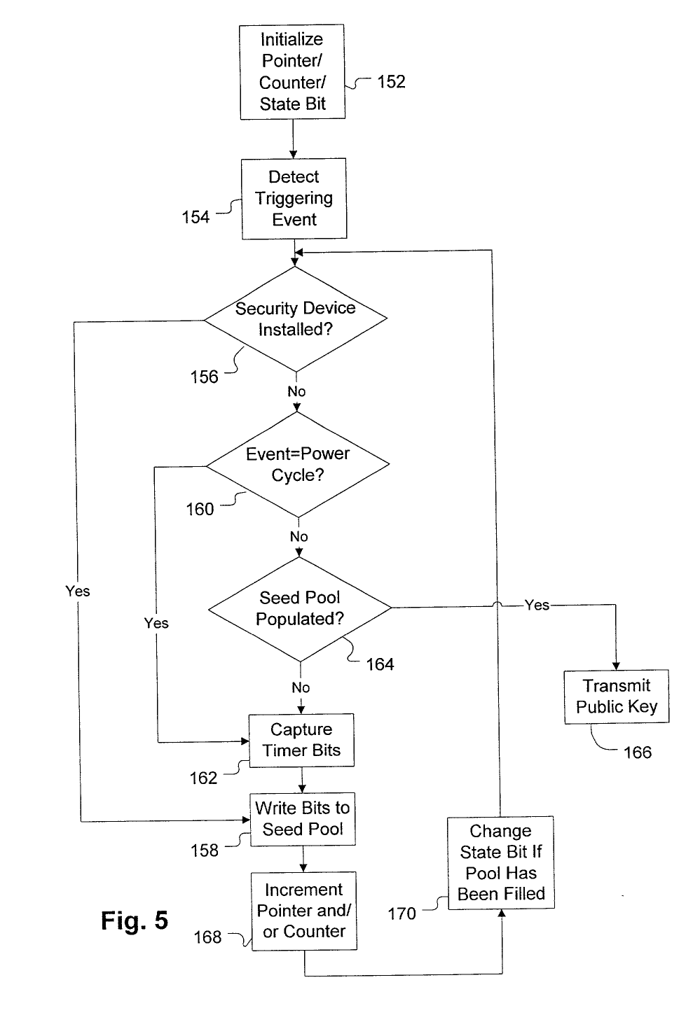

The security management technique described above and implemented by the communications management module 110 is further represented in the flowcharts in FIGS. 4 and 5. FIG. 4 illustrates an exemplary initiation of a communication session between the server 100 and an external device 104, and FIG. 5 illustrates an exemplary technique for populating the seed pool 122.

Turning first to FIG. 4, in block 138, the external device 104 establishes a connection to the server 100 via the communication link 106 and the communication interface 102. In an embodiment in which the interface 102 includes a network interface controller, the communication link 106 may include the Internet. When the external device 104 attempts to connect to the server 100, the external device 104 may transmit information, such as a digital certificate, which authenticates the device's 104 identity and its authorization to access the server 100. In the exemplary embodiment, the external device 104 also queries the server 100 to determine whether the seed pool 122 stored in the memory 112 of the server 100 is populated (block 140). If the seed pool 122 is not present or adequately populated, then the communications management system 104 cannot obtain a random number for generating the public/private key pair for the cryptographic security system. If the keys cannot be generated, then communications between the server 100 and the device 104 cannot proceed. Accordingly, the device 104 repeats the query until an affirmative response is received or until the query times out, indicating an operational error.

If the server 100 does have an adequate seed pool or once the seed pool is populated such that the server can provide an affirmative response to the query, and provided the server 100 has verified that the external device 104 has the appropriate authorization, the server 100 transmits information to the device 104 which allows it to log on and initiate a session. For instance, the server 100 may transmit a digital certificate which authenticates the server's identity along with a Java applet which allows the device 104 to log on to the server 100 and function as a Web browser (e.g., a Secure Socket Layer (SSL)—enabled browser). The information transmitted from the server 100 to the device 104 also includes the public key for the cryptographic algorithm that allows the device 104 and the server 100 to exchange communications.

Upon receipt of the public key (block 142), the external device 104 generates a session key and encrypts it using the server's public key (block 144). The device 104 may include, for instance, a random number generator which provides a random number used to generate the session key. The encrypted session key then is transmitted to the server 100 (block 146), which decrypts it using the corresponding private key (block 148). Because both the server 100 and the device 104 now have knowledge of the shared, secret session key, communications between the server 100 and the device 104 may thereafter proceed using the session key and a symmetric cryptographic algorithm (block 150).

Turning now to FIG. 5, it illustrates an exemplary technique for populating the seed pool 122. At block 152, the seed pool generation logic is initialized, which may include, for instance, initializing the pointer logic 136, setting or resetting counters, and setting or resetting the state of the state bit 132. Such initialization of logic may occur, for example, as a part of the system initialization during the manufacturing process, or as a result of the backup power source 118 being removed and replaced. Once the seed pool generation logic is reset, the seed pool 122 can be populated with an appropriate number of randomly generated bits based on the occurrence of one or more types of triggering events. In the exemplary embodiment, the types of triggering events include installation of the security device 124 and receipt of a write request to the seed pool 122, detection of a cycle of the main power source 116, and receipt of a query from an external device 104 that is attempting to access the server 100 via the communications management system 110.

If the triggering event is installation of a security device 124 (block 156), then the write access to the memory 112 is granted, and the bits are written to the seed pool 122 (block 158). This type of triggering event may occur as part of the initialization of the server 100 during the manufacturing process or during a service event. The bits written to the seed pool 122 may be generated by, for instance, a conventional random bit generator that is not a part of the server 100.

If a security device 124 is not detected, and the triggering event is a cycle of the main power source 116, then one or more bits of a random bit generator (e.g., the timer 134) are captured (block 162) and written to the seed pool 122 (block 158). The location in the memory 112 to which the one or more bits are written may be indicated by the pointer logic 136.

If a security device 124 has not been installed and the main power source has not been cycled, then the triggering event is a query from an external device 104 which is requesting access to the server 100 via the interface 102 and the communications management system 110. If such a query is received, and it is determined that the seed pool 122 already is adequately populated such that a strong random number can be provided (block 164), then the public/private key pair is generated and the public key is transmitted to the external device 104 (block 166). On the other hand, if the seed pool 122 is not adequately populated, then one or more bits of the random bit generator (e.g., the timer 134) are captured (block 162) and written to the seed pool 122 at the appropriate location in the memory 112 (block 158).

When the bits are written to the seed pool 122 (block 158), the pointer logic 136 may be incremented to point to a next location in the memory 112 for subsequent bits to be added to the seed pool. Further, if a counter is implemented which counts the number of bits written to the pool 122 or the number of queries received from the external device 104, then the counter also may be incremented, if appropriate. Still further, if the seed pool 122 has been filled as a result of the write to the memory 112 at block 158, then the state of the bit 132 may be changed to indicate that the pool 122 is fully populated. The seed pool generation logic then is ready to detect the next triggering event.

Although the invention has been described with respect to communications between an external device 104 and a communications management system 108 within the server 100, it should be understood that the technique for generating a strong random number may also be implemented in a system in which communications with the communications management system are internal to the server. For instance, initialization of the seed pool may be triggered when an application program or Web browser in the host processing system 108 attempts to access the communications management system 110 (i.e., a communication packet is received).

For the embodiments described above, the triggering event generally corresponds to receipt of a communication packet from another entity or a main power cycle. It should be understood, however, that any type of triggering event having an unpredictable and variable latency may be used to generate the seed pool. Further, although the invention has been described with respect to generating a random number for use in conjunction with a cryptographic security system, it should be understood that any type of system which uses random numbers can benefit from the novel technique.

The foregoing description has addressed the problem of restoring the seed pool to the non-volatile memory. It should be understood that the technique for restoring the seed pool also may be used to initialize the seed pool during the manufacturing process. In the manufacturing environment, however, the cryptographic security subsystem may hinder the efficient assembly and testing of a device 100 (e.g., a server). For instance, a manufacturing process typically includes installation of software and testing which involves the establishment of communications between the server 100 and an external device 104 via a communication link 106. During this process, power to the server may be cycled several times. If the security subsystem has been established, then each time power is cycled or the server 100 is rebooted, a secure connection between the server 100 and the external device 104 must be established (e.g., an SSL session initiated). Further, once the connection is established, a technician then must provide a login identifier and a password before access to the server 100 is permitted.

Establishment of a secure connection and provision of a login identifier and password are time-consuming and may require special knowledge on the part of the technician. Because the manufacturing environment presumably is a secure environment, extra time and effort consumed due to the presence of a security subsystem may be wasteful. On the other hand, the security subsystem must be installed during manufacturing to ensure that the server 100 does not escape the secure manufacturing environment without proper safeguards.

As previously discussed, the security device 114 may be installed in the server 100 to bypass the security subsystem during manufacturing. However, risks are associated with the security device 114 as a possibility exists that the server 100 may leave the manufacturing environment without the security device 114 having been removed.

To alleviate the concerns with the use of the security device 114 and to eliminate the inefficiencies introduced by the cryptographic security subsystem in the manufacturing environment, the security logic 120 can be configured such that the security features are bypassed based on the state of the seed pool 122. For instance, in one embodiment, the seed pool 122 initially may be populated during manufacturing with a pattern of bits having a known signature. As long as the seed pool 122 contains the signature value (or a significant portion of the signature value as will be explained below), then the security subsystem is bypassed. Thus, the establishment of a secure session involving the exchange of cryptographic keys and the need to enter a login identifier and password can be avoided.

In most manufacturing environments, main power is cycled to the server 100 and/or the server 100 may be rebooted several times. As previously discussed, a main power cycle or a reboot is a triggering event which results in one or more bits being masked into the seed pool 122. Thus, as the server 100 progresses through the manufacturing process, the signature value originally entered into the seed pool 122 is altered. In an exemplary embodiment, to allow the server 100 to be subjected to a typical manufacturing process in which multiple power cycles or reboots normally occur, the security logic 120 is configured to remain in a bypass mode provided the contents of the seed pool 122 retain a predetermined amount of the signature value.

For instance, if five triggering events (e.g., power cycles, reboots) are expected to occur during a normal manufacturing process, then it is known that bits will be masked into the seed pool 122 five times. If the security logic 120 determines that the signature value has been altered by a greater amount then would have occurred due to five triggering events, then the security logic 120 no longer will allow the security features to be bypassed. By implementing the security logic 120 in this manner, the harm that could occur from the server 100 leaving the manufacturing environment with the security subsystem bypassed is minimized, because any number of triggering events beyond the maximum number allowed for the manufacturing process will alter the signature value in the seed pool 122 sufficiently such that it will be unrecognizable to the security logic 120.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of generating a random number for a cryptographic security subsystem of a processor-based device, the method comprising the acts of:
(a) detecting occurrence of a first type of triggering event;
(b) writing one or more bits of data to a seed pool upon termination of the first type of triggering event; and
(c) repeating acts (a) and (b) until the seed pool is full.

2. The method as recited in claim 1, wherein act (b) comprises the act of capturing one or more bits of data from a free-running timer upon termination of the first type of triggering event.

3. The method as recited in claim 1, wherein the first type of triggering event has a variable duration.

4. The method as recited in claim 1, wherein the processor-based device is coupled to a communication link, and wherein act (a) comprises the act of receiving a communication from the communication link.

5. The method as recited in claim 4, wherein the communication link comprises a network.

6. The method as recited in claim 4, wherein the communication link comprises the Internet.

7. The method as recited in claim 1, comprising the acts of
(d) detecting occurrence of a second type of triggering event;
(e) writing one or more bits of data to the seed pool upon termination of the second type of triggering event; and
(f) repeating act (e) each time the second type of triggering event is detected.

8. The method as recited in claim 7, wherein act (e) comprises masking the one or more bits of data into the seed pool upon termination of the second type of triggering event.

9. The method as recited in claim 8, wherein act (e) comprises capturing the one or more bits of data from a free-running timer upon termination of the second type of triggering event.

10. The method as recited in claim 7, wherein the second type of triggering event is different than the first type of triggering event.

11. The method as recited in claim 7, wherein the second type of triggering event is a cycle of power applied to the processor-based device.

12. The method as recited in claim 1, wherein the seed pool comprises a state bit indicative of a state of the seed pool, and wherein the method comprises the act of examining the state bit to determine whether the seed pool is full.

13. A method of initializing a seed pool for generating a random number for a cryptographic security subsystem of a processor-based device, the method comprising the acts of:
(a) writing a plurality of bits of data to a seed pool, the plurality of bits of data having a signature value;
(b) detecting occurrence of a first type of triggering event;
(c) writing one or more bits of data to the seed pool upon termination of the first type of triggering event, the one or more bits of data altering the signature value of the seed pool; and
(d) enabling the cryptographic security subsystem when more than a predetermined portion of the signature value of the seed pool has been altered.

14. The method as recited in claim 13, wherein the first type of triggering event comprises a cycle of power applied to the processor-based device.

15. The method as recited in claim 13, wherein the first type of triggering event is a reboot of the processor-based device.

16. The method as recited in claim 13, wherein act (c) comprises the act of masking the one or more bits of data into the seed pool.

17. The method as recited in claim 13, wherein act (c) comprises the act of capturing the one or more bits of data from a free-running timer.

18. The method as recited in claim 13, comprising the acts of:
detecting a second type of triggering event;
determining if the seed pool is full; and
writing one or more bits of data to the seed pool upon termination of the second type of triggering event if the seed pool is not full.

19. A processor-based device comprising:
a host processing system, the host processing system comprising a processor;
a communications management system in communication with the host processing system;
a memory system in communication with the host processing system and the communications management system,
wherein the communications management system comprises:
an interface controller;
a non-volatile memory device to store a seed pool; and
security logic in communication with the interface controller and the non-volatile memory device, the security logic configured to generate a cryptographic key to establish a secure communication session between the processor-based device and an external device in communication with the processor-based device via the interface controller, wherein the security logic generates the cryptographic key from the seed pool stored in the non-volatile memory device, and wherein the security logic is configured to:
detect occurrence of a first type of triggering event;
determine whether the seed pool is fully populated; and
write one or more bits of data to the seed pool upon termination of the first type of triggering event if the seed pool is not fully populated.

20. The processor-based device as recited in claim 19, wherein the security logic is configured to:
detect occurrence of a second type of triggering event;
write one or more bits of data to the seed pool upon termination of the second type of triggering event.

21. The processor-based device as recited in claim 19, wherein the communications management system comprises a free-running timer, and wherein the security logic is configured to capture the one or more bits of data from the free-running timer upon termination of the first type of triggering event.

22. The processor-based device as recited in claim 19, wherein the first type of triggering event has a variable duration.

23. The processor-based device as recited in claim 19, wherein the first type of triggering event comprises receipt, by the interface controller, of a communication from an external device.

24. The processor-based device as recited in claim 23, wherein the interface controller comprises a network interface controller.

25. The processor-based device as recited in claim 23, wherein the interface controller comprises an RS232 interface controller.

26. The processor-based device as recited in claim 19, wherein the processor-based device comprises a main power supply to supply power to the processor-based device, and wherein the second type of triggering event comprises a cycle of the power supplied by the main power supply.

27. A processor-based device comprising:
a host processing system, the host processing system comprising a processor;
a communications management system in communication with the host processing system; and
a memory system in communication with the host processing system and the communications management system,
wherein the communications management system comprises:
an interface controller;
a non-volatile memory device to store a seed pool comprising a plurality of data bits; and
security logic in communication with the interface controller and the non-volatile memory device, the security logic configured to establish a secure communication session between the processor-based device and an external device in communication with the processor-based device via the interface controller, and wherein the security logic is configured to:
determine whether the plurality of data bits in the seed pool has at least a portion of a signature value; and
disable establishment of the secure communication session if the plurality of data bits has at least a portion of the signature value.

28. The processor-based device as recited in claim 27, wherein the security logic is configured to detect a first type of triggering event, and to write one or more data bits to the seed pool upon termination of the first type of triggering event.

29. The processor-based device as recited in claim 28, comprising a main power supply to supply power to the processor-based device, and wherein the first type of triggering event comprises a cycle of the power supplied by the main power supply.

30. The processor-based device as recited in claim 27, wherein the security logic is configured to:
detect a second type of triggering event;
determine whether the seed pool is fully populated; and
write one or more data bits to the seed pool upon termination of the second type of triggering event if the seed pool is not fully populated.

31. The processor-based device as recited in claim 30, wherein the second type of triggering event comprises receipt of a communication from the external device via the interface controller.

32. The processor-based device as recited in claim 31, wherein the interface controller comprises a network interface controller.
